(19) United States
(12) Patent Application Publication
(10) Pub. No.: US 2015/0304748 A1
(43) Pub. Date: Oct. 22, 2015

(54) LOUDSPEAKER

(71) Applicant: ZORZO CO., LTD., Tokyo (JP)

(72) Inventor: Teppei YAMADA, Tokyo (JP)

(21) Appl. No.: 14/677,003

(22) Filed: Apr. 2, 2015

(30) Foreign Application Priority Data
Apr. 17, 2014 (JP) 2014-002010U

(51) Int. Cl. H04R 1/02

(52) U.S. Cl. CPC H04R 1/02

(57) ABSTRACT

A loudspeaker includes a hermetically-sealed enclosure, a first driver arranged at outside of the enclosure and along a wall of the enclosure, a second driver arranged at inside of the enclosure and parallel to the first driver across the wall of the enclosure from the first driver, and a pipe communicating the first driver and the second driver. Each of the drivers has a diaphragm, and a frame surrounding the diaphragm. The frame has an opening. The pipe is connected to the opening of the frame of the first driver, penetrates through the wall of the enclosure, and is connected to the opening of the frame of the second driver, and thereby forming one hermetically-sealed space enclosed with the diaphragms and the frames of the two drivers. The second driver is configured to output a signal of opposite phase to that of the first driver.

### BACKGROUND OF THE INVENTION

1. Technical Field

The present invention relates to a loudspeaker which enables to faithfully reproduce original sound from media resource.

2. Background Art

In conventional enclosure-type or cabinet-type loudspeakers, a problem of back pressure of a driver is difficult to avoid. Only one solution to avoid it is to use a flat baffle plate. But an enormous flat baffle plate is required to configure a perfect loudspeaker by using a flat baffle plate. So, it has a fault in practical use.

A loudspeaker 10 illustrated in FIG. 2 employs a tandem drive system. The loudspeaker 10 is double enclosure type, having one enclosure 11a and a driver 12a, and another enclosure 11b and a driver 12b behind them. This is put into practical use by EgglestonWorks. In this, a diaphragm 13b of the rear driver 12b moves simultaneously in the same phase as a diaphragm 13a of the front driver 12a moves forward. It is said that this makes pressure in the front loudspeaker box always same as an outside pressure, and thereby the problem of back pressure of the diaphragm is resolved.

However, this system does not produce desired effect. The reason is that air moves slowly, air compresses and expands easily, and thereby the front diaphragm 13a begins to move before air delivered by the driver 12b arrives behind the front driver 12a. Therefore, a fundamental solution of the problem of back pressure is not achieved. This results that part of electric energy is not converted to vibrational energy of air, and becomes energy moving the driver and therefore the entire loudspeaker. Thus, a problem remains in accuracy of reproduced sound.

### SUMMARY OF THE INVENTION

The present invention aims to solve the above-mentioned problem. That is, the present invention aims to cancel reaction of the diaphragm, and to remove the problem of back pressure of the loudspeaker.

A loudspeaker according to the present invention has a hermetically-sealed enclosure, a first driver arranged at outside of the enclosure and along a wall of the enclosure, a second driver arranged at inside of the enclosure and parallel to the first driver across the wall of the enclosure from the first driver, and a pipe communicating the first driver and the second driver. Each of the drivers has a diaphragm and a frame surrounding the diaphragm. The frame has an opening. The pipe is connected to the opening of the frame of the first driver, penetrates through the wall of the enclosure, and is connected to the opening of the frame of the second driver, and thereby forming one hermetically-sealed space enclosed with the diaphragms and the frames of the two drivers. The second driver is configured to output a signal of opposite phase to that of the first driver.

The frame may have a second opening, and a cover member may stem the second opening.

The pipe may communicate the two drivers in the shortest distance.

In the loudspeaker according to the present invention, the two drivers are adjacent in the shortest distance, and the pipe communicating between the openings of the frames of the two drivers connects the frames of them, forming the hermetically-sealed space. Therefore, the space connecting the drivers is very small, and thereby the two drivers operate in exact synchronization with tight motion relation. This improves resonant frequency Fo of the drivers connected by the pipe, and achieves open and clear reproduced sound.

### BRIEF DESCRIPTION OF THE DRAWINGS

FIG. 1 shows a vertical cross-sectional view of a loudspeaker of an example of the present invention.

FIG. 2 shows a vertical cross-sectional view of a loudspeaker of a related art.

### DESCRIPTION OF THE PREFERRED EMBODIMENTS

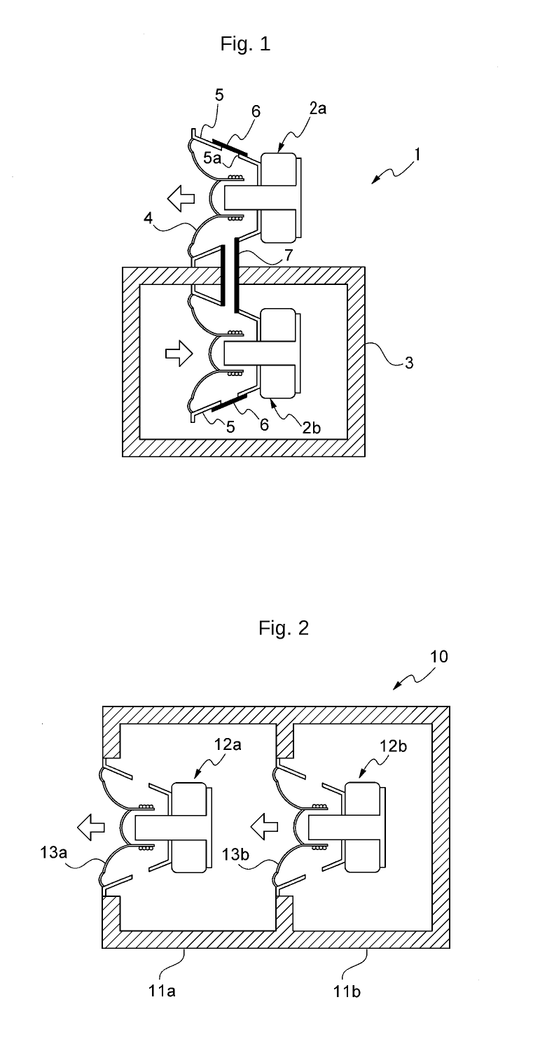

As shown in FIG. 1, a loudspeaker 1 of an example of the present invention has a enclosure 3 having a box shape and hermetically sealed at six faces, a driver 2a arranged at outside of the enclosure 3 and along a wall of an upper face, or a top plate, of the enclosure 3, a driver 2b arranged at inside of the enclosure 3 and parallel to the driver 2a across the wall of the upper face of the enclosure 3 from the driver 2a, and a pipe 7 communicating the driver 2a and the driver 2b in the shortest distance.

Each of the drivers 2a and 2b has frame 5 surrounding a diaphragm 4, and a cover member 6 stemming an opening 5a of the frame 5. On the frame 5, plural openings 5a are formed. The pipe 7 is connected to one of the openings 5a of the driver 2a, penetrates through the wall of the upper face of the enclosure 3, and is connected to one of the openings 5a of the driver 2b. The cover members 6 stem all openings 5a except the openings 5a connected to the pipe 7.

The cover members 6 stemming the other openings 5a of the frame 5 than the openings 5a connected to the pipe 7 forms a hermetically-sealed space communicated by the pipe 7 among the diaphragms 4 and the frames 5 of the drivers 2a and 2b. The pipe 7 is, for example, plastics, and is stuck to the drivers 2a and 2b by epoxy-based adhesive. But the pipe 7 may be formed of other materials as far as it has high airtightness and is hardly deformable.

The driver 2a, arranged at outside of the enclosure 3, reproduces a sound signal recorded on a media resource, such as CD, faithfully as it is. The driver 2b, arranged at inside of the enclosure 3, reproduces a sound signal having opposite phase to that reproduced by the driver 2a. Thus, when the diaphragm 4 of the driver 2a is driven to a direction as shown by the left-directed arrow in the figure, the diaphragm 4 of the driver 2b is driven to an opposite direction to that of the driver 2a, as shown by the right-directed arrow in the figure.

Since the loudspeaker 1 is configured as described above, sonic vibration generated at a back side of the diaphragm 4 of the driver 2a is canceled by sonic vibration having opposite phase generated from the driver 2b. In other words, sound as well as air pressure disappears by mutually canceling in the hermetically-sealed space communicated by the pipe 7. Therefore, the driver 2a can faithfully reproduce a sound signal recorded on the media resource without bad influence of reaction and back pressure of the diaphragm 4.

The loudspeaker according to the present invention can faithfully reproduce a sound signal recorded on a media resource, and can be widely used as an audio equipment.

A resonant frequency Fo reduced by about 20% according to inventor's experiment. Improving Fo makes enable to produce a full-range loudspeaker with small diameter.

Various modifications and changes may be applied to the above-described embodiments. This can be readily appreciated by a person skilled in the art. The present invention is not limited to the above-described embodiments, and includes modified and/or changed ones, without departing from a scope defined by the appended claims.

What is claimed is:

1. A loudspeaker, comprising:
a hermetically-sealed enclosure;
a first driver arranged along a wall of the enclosure at outside of the enclosure;
a second driver arranged parallel to the first driver across the wall of the enclosure from the first driver at inside of the enclosure; and
a pipe communicating the first driver and the second driver, wherein
each of the drivers has a diaphragm, and a frame surrounding the diaphragm,
the frame has a opening,
the pipe is connected to the opening of the frame of the first driver, penetrates through the wall of the enclosure, and is connected to the opening of the frame of the second driver, and thereby forming one hermetically-sealed space enclosed with the diaphragms and the frames of the two drivers, and
the second driver is configured to output a signal of opposite phase to that of the first driver.

2. The loudspeaker of claim 1, wherein
the frame has a second opening, and
a cover member stems the second opening.

3. The loudspeaker of claim 1, wherein
the pipe communicates the two drivers in the shortest distance.
